(19) United States
(12) Patent Application Publication
(10) Pub. No.: US 2019/0326817 A1
(43) Pub. Date: Oct. 24, 2019

(54) DRIVING CIRCUIT AND BOOTSTRAP VOLTAGE REFRESH METHOD FOR BUCK-BOOST CONVERTER

(71) Applicant: Chengdu Monolithic Power Systems Co. Ltd., Chengdu (CN)

(72) Inventor: Jian Zhang, Chengdu (CN)

(21) Appl. No.: 16/375,821

(22) Filed: Apr. 4, 2019

(30) Foreign Application Priority Data
Apr. 20, 2018 (CN) 201810361022.9

(51) Int. Cl. H02M 3/158; H02M 1/08

(52) U.S. Cl. CPC H02M 3/1582; H02M 1/08

(57) ABSTRACT

A driving circuit and a bootstrap voltage refresh method used for buck-boost converter. The driving circuit includes a first bootstrap capacitor connected between a first bootstrap node and a common connection of a first power switch and a third power switch, a second bootstrap capacitor connected between a second bootstrap node and a common connection of a second power switch and a fourth power switch. When the second bootstrap voltage is smaller than a threshold in buck mode, the first bootstrap node is connected with the second bootstrap node when the first power switch is turned on. When the first bootstrap voltage is smaller than the threshold in boost mode, the first bootstrap node is connected with the second bootstrap node when the second power switch is turned on.

### CROSS REFERENCE

This application claims the benefit of CN application No. 201810361022.9 filed on Apr. 20, 2018 and incorporated herein by reference.

### TECHNICAL FIELD

This disclosure generally relates to buck-boost power converters, and more particularly but not exclusively relates to driving circuit and bootstrap voltage refresh method of buck-boost power converters.

### BACKGROUND

Buck-boost power converters can convert an input voltage into an output voltage higher than, equal to or lower than the input voltage and can generally be operated with wide input voltage range. Therefore, buck-boost power converters are widely used in power management applications.

FIG. 1 illustrates a conventional buck-boost power converter 50 with bootstrap circuits. The buck-boost power converter 50 comprises a first power switch 11, a second power switch 12, a third power switch 13 and a fourth power switch 14. The first power switch 11 and the third power switch 13 are coupled in series between an input port IN and a reference ground, and have a common connection referred to as a first switching node SW1. The second power switch 12 and the fourth power switch 14 are coupled in series between an output port OUT and the reference ground, and have a common connection referred to as a second switching node SW2. An inductor 15 is coupled between the first switching node SW1 and the second switching node SW2. A capacitor 16 is coupled between the output port OUT and the reference ground. An input voltage VIN at the input port IN is converted to an output voltage VOUT at the output port OUT through controlling the power switches 11-14 on and off.

If the first power switch 11 and the second power switch 12 are N channel power switching devices (e.g., N channel field effect transistors, N channel double diffused metal oxide semiconductor transistors etc.), bootstrap circuits should be provided to enhance the driving capability of the corresponding drivers 21 and 22. Generally, bootstrap circuits comprise a power supply VCC, a first bootstrap capacitor 31, a second bootstrap capacitor 33, a first diode 32 and a second diode 34. The first bootstrap capacitor 31 coupled between the first switching node SW1 and the power supply VCC via the first diode 32 is configured to generate a first bootstrap voltage VBST1 referenced with the voltage at the first switching node SW1 to enhance the driving capability of the corresponding driver 21 to fully turn the first power switch 11 on and off, and a second bootstrap capacitor 33 coupled between the second switching node SW2 and the power supply VCC via the diode 34 is configured to generate a second bootstrap voltage VBST2 referenced with the voltage at the second switching node SW2 to enhance the driving capability of the corresponding driver 22 to fully turn the second power switch 12 on and off.

However, when the buck-boost power converter 50 operates in a buck mode, the first power switch 11 and the third power switch 13 are switched on and off while the second power switch 12 is kept on and the fourth power switch 14 is kept off, thus the voltage on the second switching mode SW2 is equal to the output voltage signal VOUT which may result the power supply VCC is unable to charge the second bootstrap capacitor 33 to get a desired value of the second bootstrap voltage VBST2. When the buck-boost power converter 50 operates in a boost mode, the second power switch 12 and the fourth power switch 14 are switched on and off while the first power switch 11 is kept on and the third power switch 13 is kept off, thus the voltage on the first switching mode SW1 is equal to the input voltage signal VIN which may result the power supply VCC is unable to charge the first bootstrap capacitor 31 to get a desired value of the first bootstrap voltage VBST1.

Therefore, it is desired to have a solution for efficiently refreshing the first bootstrap voltage VBST1 and the second bootstrap voltage VBST2 in buck-boost power converters.

### SUMMARY

Embodiments of the present invention are directed to a driving circuit for a buck-boost power converter having a first power switch and a third power switch coupled in series between an input port and a reference ground, and a second power switch and a fourth power switch coupled in series between an output port and the reference ground. The driving circuit comprises: a first bootstrap capacitor, coupled between a first bootstrap node and a common connection of the first power switch and the third power switch, and configured to provide a first bootstrap voltage signal to drive the first power switch; a second bootstrap capacitor, coupled between a second bootstrap node and a common connection of the second power switch and the fourth power switch, and configured to provide a second bootstrap voltage signal to drive the second power switch; a power supply, wherein the first bootstrap node and the second bootstrap node are respectively coupled to the power supply; and a bootstrap refresh circuit; wherein when the buck-boost power converter operates in a buck mode and the second bootstrap voltage signal is smaller than a first refresh threshold, the bootstrap refresh circuit is configured to connect the first bootstrap node with the second bootstrap node when the first power switch is turned on; and wherein when the buck-boost power converter operates in a boost mode and the first bootstrap voltage signal is smaller than a second refresh threshold, the bootstrap refresh circuit is configured to connect the first bootstrap node with the second bootstrap node when the second power switch is turned on.

Embodiments of the present invention are further directed to a control circuit for a buck-boost power converter having a first power switch and a third power switch coupled in series between an input port and a reference ground, a second power switch and a fourth power switch coupled in series between an output port and the reference ground, comprising a driving circuit and a controller. The driving circuit comprises: a first bootstrap capacitor, coupled between a first bootstrap node and a common connection of the first power switch and the third power switch and configured to provide a first bootstrap voltage signal to drive the first power switch; a second bootstrap capacitor, coupled between a second bootstrap node and a common connection of the second power switch and the fourth power switch, and configured to provide a second bootstrap voltage signal to drive the second power switch; and a bootstrap refresh circuit; and a power supply, wherein the first bootstrap node and the second bootstrap node are respectively coupled to the power supply; and a controller, configured to receive a feedback signal indicative of an output voltage signal, and further configured to generate a first control signal, a second control signal, a third control signal, a fourth control signal, a first enable signal and a second enable signal based on the feedback signal, wherein the first control signal, the second control signal, the third control signal and the fourth control signal are respectively configured to control the first power switch, the second power switch, the third power switch and the fourth power switch; and wherein when the buck-boost power converter operates in a buck mode and the second bootstrap voltage signal is smaller than a first refresh threshold, the first enable signal is configured to enable the bootstrap refresh circuit to connect the first bootstrap node with the second bootstrap node when the first power switch is turned on; and wherein when the buck-boost power converter operates in a boost mode and the first bootstrap voltage signal is smaller than a second refresh threshold, the second enable signal is configured to enable the bootstrap refresh circuit to connect the first bootstrap node with the second bootstrap node when the second power switch is turned on.

Embodiments of the present invention are further directed to a bootstrap voltage refresh method for a buck-boost power converter having a first power switch and a third power switch coupled in series between an input port and a reference ground, a second power switch and a fourth power switch coupled in series between an output port and the reference ground, a first bootstrap capacitor coupled between a first bootstrap node and a common connection of the first power switch and the third power switch and configured to provide a first bootstrap voltage signal to drive the first power switch, and a second bootstrap capacitor coupled between a second bootstrap node and a common connection of the second power switch and the fourth power switch and configured to provide a second bootstrap voltage signal to drive the second power switch, and the bootstrap voltage refresh method comprising: determining an operating mode of the buck-boost power converter; when the operating mode is a buck mode: determining whether the second bootstrap voltage signal is smaller than a first refresh threshold; determining whether the first power switch is turned on; and connecting the first bootstrap node with the second bootstrap node when the second bootstrap voltage is smaller than the first refresh threshold and the first power switch is turned on; when the operating mode is a boost mode: determining whether the first bootstrap voltage signal is smaller than a second refresh threshold; determining whether the second power switch is turned on; and connecting the first bootstrap node with the second bootstrap node when the first bootstrap voltage is smaller than the second refresh threshold and the second power switch is turned on.

### BRIEF DESCRIPTION OF THE DRAWINGS

Non-limiting and non-exhaustive embodiments are described with reference to the following drawings.

FIG. 1 illustrates a conventional buck-boost power converter 50 with bootstrap circuits;

FIG. 2 illustrates a schematic diagram of a buck-boost power converter 100 in accordance with an exemplary embodiment of the present invention;

FIG. 3 illustrates a schematic diagram of a bootstrap circuit 300 in accordance with an exemplary embodiment of the present invention;

FIG. 4 illustrates a schematic diagram of the first bootstrap refresh circuit 351 of FIG. 3 in accordance with an exemplary embodiment of the present invention;

FIG. 5 illustrates a schematic diagram of the second bootstrap refresh circuit 352 of FIG. 3 in accordance with an exemplary embodiment of the present invention;

FIG. 6 illustrates a schematic diagram of a first feedback circuit 600 used for generating the first feedback signal in accordance with an exemplary embodiment of the present invention;

FIG. 7 illustrates a schematic diagram of a first feedback circuit 700 used for generating the second feedback signal in accordance with an exemplary embodiment of the present invention;

FIG. 8 illustrates a schematic diagram of a power supply generator 800 used to generate the power supply in accordance with an exemplary embodiment of the present invention;

FIG. 9 illustrates a bootstrap voltage refresh method 900 for a buck-boost power converter in accordance with an exemplary embodiment of the present invention.

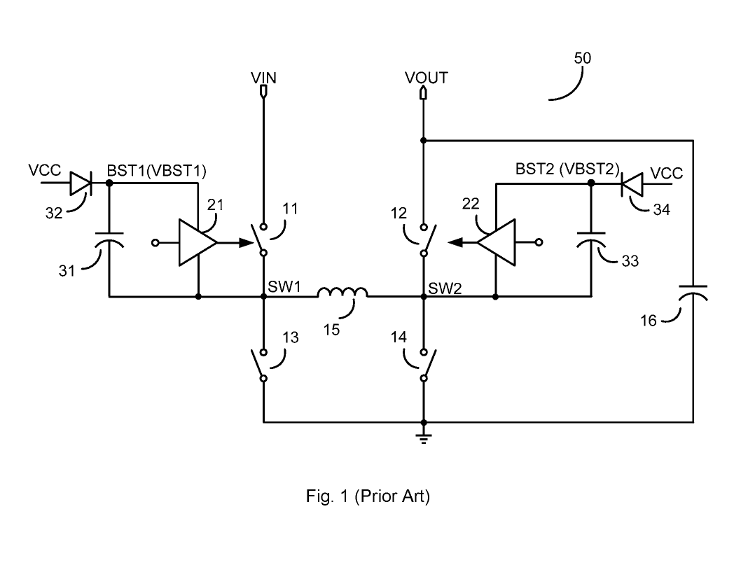

The use of the same reference label in different drawings indicates the same or like components or structures with substantially the same functions for the sake of simplicity.

### DETAILED DESCRIPTION

Various embodiments of the present invention will now be described. In the following description, some specific details, such as example circuits and example values for these circuit components, are included to provide a thorough understanding of embodiments. One skilled in the relevant art will recognize, however, that the present invention can be practiced without one or more specific details, or with other methods, components, materials, etc. In other instances, well-known structures, materials, processes or operations are not shown or described in detail to avoid obscuring aspects of the present invention.

Throughout the specification and claims, the term “coupled,” as used herein, is defined as directly or indirectly connected in an electrical or non-electrical manner. The terms “a,” “an,” and “the” include plural reference, and the term “in” includes “in” and “on”. The phrase “in one embodiment,” as used herein does not necessarily refer to the same embodiment, although it may. The term “or” is an inclusive “or” operator, and is equivalent to the term “and/or” herein, unless the context clearly dictates otherwise. The term “based on” is not exclusive and allows for being based on additional factors not described, unless the context clearly dictates otherwise. The term “circuit” means at least either a single component or a multiplicity of components, either active and/or passive, that are coupled together to provide a desired function. The term “signal” means at least one current, voltage, charge, temperature, data, or other signal. Where either a field effect transistor (“FET”) or a bipolar junction transistor (“BJT”) may be employed as an embodiment of a transistor, the scope of the words “gate”, “drain”, and “source” includes “base”, “collector”, and “emitter”, respectively, and vice versa. Those skilled in the art should understand that the meanings of the terms identified above do not necessarily limit the terms, but merely provide illustrative examples for the terms.

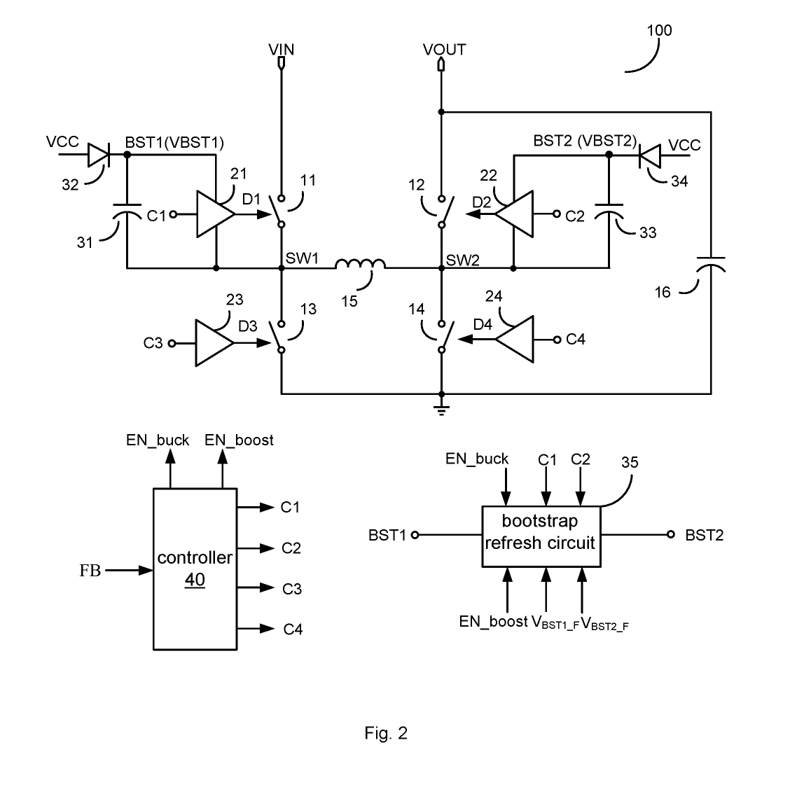

FIG. 2 illustrates a schematic diagram of a buck-boost power converter 100 in accordance with an exemplary embodiment of the present invention. as shown in FIG. 2, the buck-boost power converter 100 may comprise a first power switch 11, a second power switch 12, a third power switch 13, a fourth power switch 14, an inductor 15 and a capacitor 16. The first power switch 11 and the third power switch 13 are coupled in series between an input port IN and a reference ground, and have a common connection referred to as a first switching node SW1. The second power switch 12 and the fourth power switch 14 are coupled in series between an output port OUT and the reference ground, and have a common connection referred to as a second switching node SW2. The inductor 15 may be coupled between the first switching node SW1 and the second switching node SW2. The capacitor 16 may be coupled between the output port OUT and the reference ground. An input voltage VIN at the input port IN is converted to an output voltage VOUT at the output port OUT through controlling the power switches 11-14 on and off.

In order to decrease power consumption, the buck-boost power converter 100 may operate in different operation mode depending on different relationships of the input voltage VIN and the output voltage VOUT. In an embodiment, when the input voltage VIN is larger than the output voltage VOUT, the buck-boost power converter 100 is configured to operate in a buck mode in which the first power switch 11 and the third power switch 13 are switched on and off while the second power switch 12 is kept on and the fourth power switch 14 is kept off. In an embodiment, when the input voltage VIN is smaller than the output voltage VOUT, the buck-boost power converter 100 is configured to operate in a boost mode in which the second power switch 12 and the fourth power switch 14 are switched on and off while the first power switch 11 is kept on and the third power switch 13 is kept off. In an embodiment, when the input voltage VIN is approximately equal to the output voltage VOUT, the buck-boost power converter 100 is configured to operate in a buck-boost mode.

In the exemplary embodiment of FIG. 2, the buck-boost power converter 100 may further comprise a control circuit which may comprise a controller 40 and a driving circuit.

The controller 40 may be configured to receive a feedback signal FB, and further configured to generate a first control signal C1, a second control signal C2, a third control signal C3 and a fourth control signal C4 based on the feedback signal FB, wherein the first control signal C1, the second control signal C2, the third control signal C3 and the fourth control signal C4 may be configured to respectively control the power switches 11-14. In an embodiment, the feedback signal FB may be an output voltage feedback signal indicative of the output voltage signal VOUT. In other embodiments, the feedback signal FB may be an output current feedback signal indicative of an output current signal. The controller 40 may comprise a mode determining circuit configured to determine the buck-boost power converter 100 to operate in the buck mode, the boost mode or the buck-boost mode based on the feedback signal FB, and further configured to generate a first enable signal EN_buck and a second enable signal EN_boost. In an embodiment, when the buck-boost power converter 100 operates in the buck mode, the first enable signal EN_buck is active and the second enable signal EN_boost is inactive; when the buck-boost power converter 100 operates in the boost mode, the first enable signal EN_buck is inactive and the second enable signal EN_boost is active; when the buck-boost power converter 100 operates in the buck-boost mode, neither of the first enable signal EN_buck and the second enable signal EN_boost are active.

The driving circuit may comprise a first driver 21, a second driver 22, a third driver 23, a fourth driver 24 and a bootstrap circuit, wherein the first driver 21, the second driver 22, the third driver 23 and the fourth driver 24 are respectively to drive the power switches 11˜14. In detail, the first driver 21 may comprise a first supply terminal coupled to a first bootstrap voltage supply node BST1 to receive a first bootstrap voltage VBST1, a second supply terminal coupled to the first switching mode SW1, an input terminal configured to receive the first control signal C1, and an output terminal configured to provide a first driving signal D1 for driving the first power switch 11 on and off. The second driver 22 may comprise a first supply terminal coupled to a second bootstrap voltage supply node BST2 to receive a second bootstrap voltage VBST2, a second supply terminal coupled to the second switching mode SW2, an input terminal configured to receive the second control signal C2, and an output terminal configured to provide a second driving signal D2 for driving the second power switch 12 on and off. The third driver 23 may be configured to receive the third control signal C3 to generate a third driving signal D3 for driving the third power switch 13 on and off. The fourth driver 24 may be configured to receive the fourth control signal C4 to generate a fourth driving signal D4 for driving the fourth power switch 14 on and off.

The bootstrap circuit may comprise a first bootstrap capacitor 31, a second bootstrap capacitor 33, a first diode 32, a second diode 34 and a bootstrap refresh circuit 35. The first bootstrap capacitor 31 may be coupled between the first bootstrap voltage supply node BST1 and the first switching node SW1. An anode of the first diode 32 may be coupled to the power supply VCC, and a cathode of the first diode 32 may be coupled to the first bootstrap voltage supply node BST1. The power supply VCC may charge the first bootstrap capacitor 31 through the first diode 32 to generate the first bootstrap voltage VBST1 which is the voltage across the first bootstrap capacitor 31 referenced with the voltage at the first switching node SW1. The first bootstrap voltage VBST1 is configured to enhance the driving capability of the first driver 21 to fully turn the first power switch 11 on and off. The second bootstrap capacitor 33 may be coupled between the second bootstrap voltage supply node BST2 and the second switching node SW2. An anode of the second diode 34 may be coupled to the power supply VCC, and a cathode of the second diode 34 may be coupled to the second bootstrap voltage supply node BST2. The power supply VCC may charge the second bootstrap capacitor 33 through the second diode 34 to generate the second bootstrap voltage VBST2 which is the voltage across the second bootstrap capacitor 33 referenced with the voltage at the second switching node SW2. The second bootstrap voltage VBST2 is configured to enhance the driving capability of the second driver 22 to fully turn the second power switch 12 on and off.

The bootstrap refresh circuit 35 may be configured to receive a first feedback signal VBST1_F indicative of the first bootstrap voltage signal VBST1, a second feedback signal VBST2_F indicative of the second bootstrap voltage signal VBST2, and coupled to the controller 40 to receive the first control signal C1, the second control signal C2, the first enable signal EN_buck and the second enable signal EN_boost, and further configured to generate the first bootstrap voltage VBST1 at the first bootstrap voltage supply node BST1 and the second bootstrap voltage VBST2 at the second bootstrap voltage supply node BST2 based on the first feedback signal VBST1_F, the second feedback signal VBST2_F, the first control signal C1, the second control signal C2, the first enable signal EN_buck and the second enable signal EN_boost. During the buck mode, the first power switch 11 and the third power switch 13 are switched on and off while the second power switch 12 is kept on and the fourth power switch 14 is kept off, thus the voltage on the second switching mode SW2 is equal to the output voltage signal VOUT. If the second bootstrap voltage signal VBST2 is smaller than a first bootstrap refresh threshold, the power supply VCC is unable to charge the second bootstrap capacitor 33 to refresh the second bootstrap voltage signal VBST2. However, in accordance with the operation of the buck-boost power converter 100, when the first power switch 11 is turned on, the voltage on the first switching mode SW1 is equal to the input voltage signal VIN. In such an occasion, the first bootstrap voltage signal VBST1 may be larger than the second bootstrap voltage signal VBST2 as the input voltage signal VIN is larger than the output voltage signal VOUT in the buck mode. Therefore, once the second bootstrap voltage signal VBST2 is smaller than the first bootstrap refresh threshold, the bootstrap refresh circuit 35 may be configured to connect the first bootstrap voltage supply node BST1 to the second bootstrap voltage supply node BST2 so that the first bootstrap voltage signal VBST1 can be used to charge the second bootstrap capacitor 33 so as to refresh the second bootstrap voltage signal VBST2. In an embodiment, “refresh the second bootstrap voltage signal VBST2” means the second bootstrap voltage VBST2 is recovered to a desired bootstrap voltage value to supply the second driver 22 for driving the second power switch 12 on and off normally. During the boost mode, the second power switch 12 and the fourth power switch 14 are switched on and off while the first power switch 11 is kept on and the third power switch 13 is kept off, thus the voltage on the first switching mode SW1 is equal to the input voltage signal VIN. If the first bootstrap voltage signal VBST1 is smaller than a second bootstrap refresh threshold, the power supply VCC is unable to charge the first bootstrap capacitor 31 to refresh the first bootstrap voltage signal VBST1. However, in accordance with the operation of the buck-boost power converter 100, when the second power switch 12 is turned on, the voltage on the second switching mode SW2 is equal to the output voltage signal VOUT, in such an occasion, the second bootstrap voltage signal VBST2 may be larger than the first bootstrap voltage signal VBST1 as the input voltage signal VIN is smaller than the output voltage signal VOUT in the boost mode. Therefore, once the first bootstrap voltage signal VBST1 is smaller than the second bootstrap refresh threshold, the bootstrap refresh circuit 35 may be configured to connect the first bootstrap voltage supply node BST1 to the second bootstrap voltage supply node BST2 so that the second bootstrap voltage signal VBST2 can be used to charge the first bootstrap capacitor 31 so as to refresh the first bootstrap voltage signal VBST1. Similarly, “refresh the first bootstrap voltage signal VBST1” means the first bootstrap voltage VBST1 is recovered to a desired bootstrap voltage value to supply the first driver 21 for driving the first power switch 11 on and off normally. In an embodiment, the first bootstrap refresh threshold is equal to the second bootstrap refresh threshold.

In the exemplary embodiment of FIG. 2, the power switches 11-14 may be illustrated as any suitable semiconductor devices such as Metal Oxide Semiconductor Field Effect Transistors (“MOSFETs”), Junction Field Effect Transistors (“JFETs”), Insulated Gate Bipolar Translators (“IGBTs”), Double Diffusion Metal-Oxide-Semiconductor (“DMOS”), and the like.

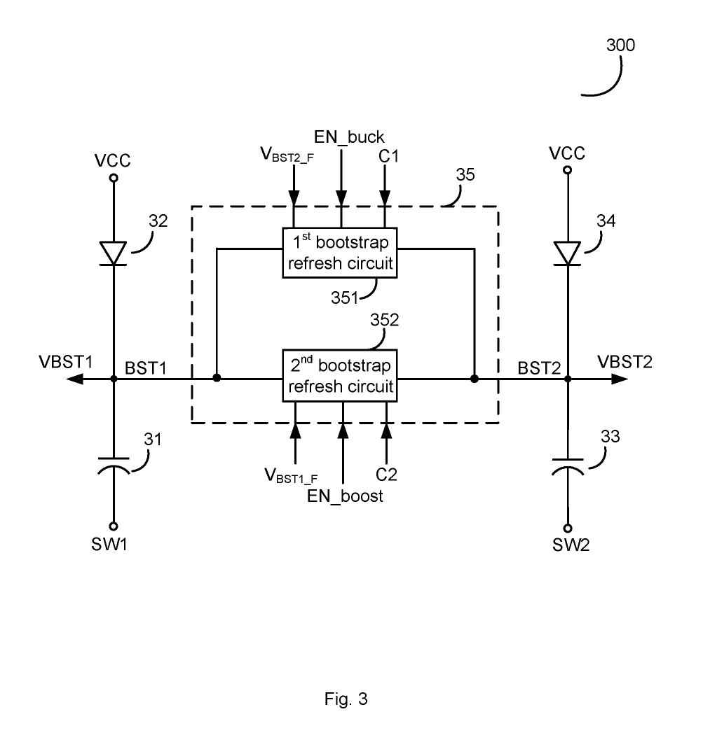

FIG. 3 illustrates a schematic diagram of a bootstrap circuit 300 in accordance with an exemplary embodiment of the present invention. As shown in FIG. 3, the bootstrap circuit 300 may comprise the first bootstrap capacitor 31, the second bootstrap capacitor 33, the first diode 32, the second diode 34 and the bootstrap refresh circuit 35. The connection relationships of the first bootstrap capacitor 31, the second bootstrap capacitor 33, the first diode 32, the second diode 34 and the bootstrap refresh circuit 35 are the same as these described in FIG. 2. For the sake of simplicity, it will not be described again. In the exemplary embodiment of FIG. 3, the bootstrap refresh circuit 35 may be illustrated to comprise a first bootstrap refresh circuit 351 and a second bootstrap refresh circuit 352.

In the exemplary embodiment of FIG. 3, the first bootstrap refresh circuit 351 may be coupled between the first bootstrap voltage supply node BST1 and the second bootstrap voltage supply node BST2, and configured to receive the second feedback signal VBST2_F, the first control signal C1 and the first enable signal EN_buck. When the buck-boost power converter 100 operates in the buck mode, the first enable signal EN_buck is activated to enable the first bootstrap refresh circuit 351, and the second enable signal EN_boost is inactive to the extent that the second bootstrap refresh circuit 352 is disabled. The first bootstrap refresh circuit 351 is configured to compare the second feedback signal VBST2_F with a first predetermined threshold. In an embodiment, the first predetermined threshold is proportional to the first refresh threshold. When the second feedback signal VBST2_F is smaller than the first predetermined threshold, the first bootstrap refresh circuit 351 may be configured to connected the first bootstrap voltage supply node BST1 to the second bootstrap voltage supply node BST2 when the first control signal C1 is active, i.e., the first power switch 11 is turned on. The first bootstrap voltage signal VBST1 is provided to the second bootstrap voltage supply node BST2 to charge the second bootstrap capacitor 33 for refreshing the second bootstrap voltage signal VBST2.

In the exemplary embodiment of FIG. 3, the second bootstrap refresh circuit 352 may also be coupled between the first bootstrap voltage supply node BST1 and the second bootstrap voltage supply node BST2, and configured to receive the first feedback signal VBST1_F, the second control signal C2 and the second enable signal EN_boost. When the buck-boost power converter 100 operates in the boost mode, the second enable signal EN_boost is activated to enable the second bootstrap refresh circuit 352, and the first enable signal EN_buck is inactive to the extent that the first bootstrap refresh circuit 351 is disabled. The second bootstrap refresh circuit 352 is configured to compare the first feedback signal VBST1_F with a second predetermined threshold. In an embodiment, the second predetermined threshold is proportional to the second refresh threshold. When the first feedback signal VBST1_F is smaller than the second predetermined threshold, the second bootstrap refresh circuit 352 may be configured to connected the first bootstrap voltage supply node BST1 to the second bootstrap voltage supply node BST2 when the second control signal C2 is active, i.e., the second power switch 12 is turned on. The second bootstrap voltage signal VBST2 is provided to the first bootstrap voltage supply node BST1 to charge the first bootstrap capacitor 31 for refreshing the first bootstrap voltage signal VBST1. In an embodiment, the second predetermined threshold is equal to the first predetermined threshold.

In the exemplary embodiment of FIG. 3, when the buck-boost power converter 100 operates in the buck-boost mode, both the first bootstrap refresh circuit 351 and the second bootstrap refresh circuit 352 are respectively disabled by the first enable signal EN_buck and the second enable signal EN_boost. No matter the buck-boost power converter 100 operates at the DCM or at a continuous current mode (CCM), the first bootstrap voltage signal VBST1 and the second bootstrap voltage signal VBST2 can be refreshed by the power supply VCC.

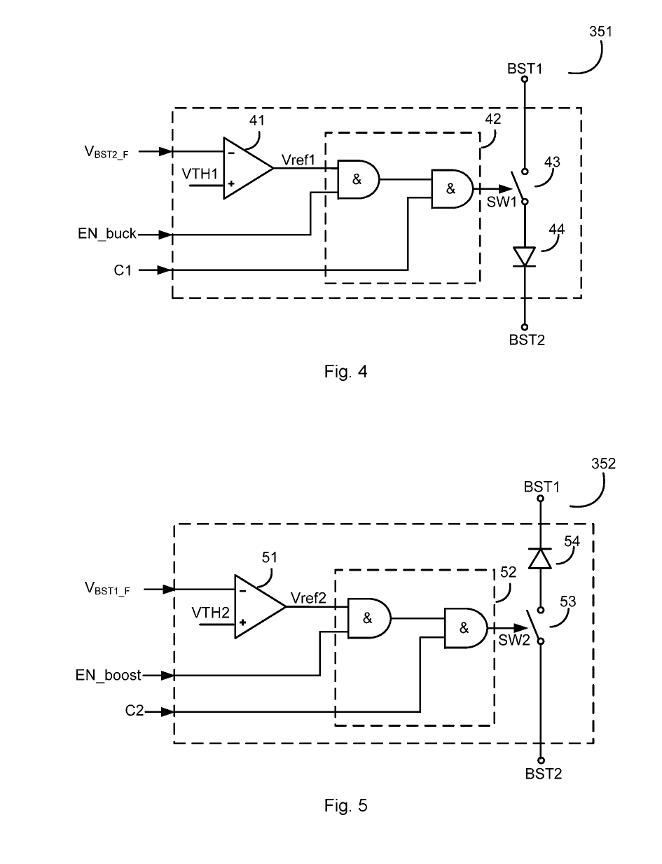

FIG. 4 illustrates a schematic diagram of the first bootstrap refresh circuit 351 of FIG. 3 in accordance with an exemplary embodiment of the present invention. As shown in FIG. 4, the first bootstrap refresh circuit 351 may comprise a first comparator 41, a first logic circuit 42, a switch 43, and a diode 44.

The first comparator 41 may comprise a first input terminal configured to receive the second feedback signal VBST2_F, a second input terminal configured to receive a first predetermined threshold VTH1, and an output terminal. The first comparator 41 may be configured to compare the second feedback signal VBST2_F with the first predetermined threshold VTH1 to generate a first refresh signal Vref1. In an embodiment, the first refresh signal Vref1 may be a logic signal with a logic high state and a logic low state. In an embodiment, when the second feedback signal VBST2_F is smaller than the first predetermined threshold VTH1, the first refresh signal Vref1 is in the active state (e.g., logic high state).

The first logic circuit 42 may be configured to receive the first refresh signal Vref1, the first enable signal EN_buck and the first control signal C1, and further configured to conduct a logic operation to the first refresh signal Vref1, the first enable signal EN_buck and the first control signal C1 to provide a first logic signal SW1 at its output terminal. In an embodiment, the first logic signal SW1 may be a logic signal with a logic high state and a logic low state. In an embodiment, only all of the first refresh signal Vref1, the first enable signal EN_buck and the first control signal C1 are in the active state (e.g., logic high state), the first logic signal SW1 is in the active state (e.g., logic high state). In an embodiment, the first logic circuit 42 may comprise two “AND” logic gates each of which may comprise two input terminals. In other embodiments, the first logic circuit 42 may comprise an “AND” logic gate having three input terminals.

The switch 43 may comprise a first terminal coupled to the first bootstrap node BST1, a second terminal coupled to the second bootstrap node BST2, and a control terminal configured to receive the first logic signal SW1. When the first logic signal SW1 is in the active state, the switch 43 is turned on so as to connect the first bootstrap node BST1 with the second bootstrap node BST2.

The diode 44 may be configured to prevent a current from flowing from the second bootstrap node BST2 to the first bootstrap node BST1. In an embodiment, an anode of the diode 44 is coupled to the first bootstrap node BST1, and a cathode of the diode 44 is coupled to the second bootstrap node BST2. In the exemplary embodiment of FIG. 4, the anode of the diode 44 is coupled to the first bootstrap node BST1 the second terminal of the switch 43, and the cathode of the diode 44 is coupled to the second bootstrap node BST2.

FIG. 5 illustrates a schematic diagram of the second bootstrap refresh circuit 352 of FIG. 3 in accordance with an exemplary embodiment of the present invention. As shown in FIG. 5, the second bootstrap refresh circuit 352 may comprise a second comparator 51, a second logic circuit 52, a switch 53 and a diode 54.

The second comparator 51 may comprise a first input terminal configured to receive the first feedback signal VBST1_F, a second input terminal configured to receive a second predetermined threshold VTH2, and an output terminal. The second comparator 51 may be configured to compare the first feedback signal VBST1_F with the second predetermined threshold VTH2 to generate a second refresh signal Vref2. In an embodiment, the second refresh signal Vref2 may be a logic signal with a logic high state and a logic low state. In an embodiment, when the first feedback signal VBST1_F is smaller than the second predetermined threshold VTH2, the second refresh signal Vref2 is in the active state (e.g., logic high state).

The second logic circuit 52 may be configured to receive the second refresh signal Vref2, the second enable signal EN_boost and the second control signal C2, and further configured to conduct a logic operation to the second refresh signal Vref2, the second enable signal EN_boost and the second control signal C2 to provide a second logic signal SW2 at its output terminal. In an embodiment, the second logic signal SW2 may be a logic signal with a logic high state and a logic low state. In an embodiment, only all of the second refresh signal Vref2, the second enable signal EN_boost and the second control signal C2 are in the active state (e.g., logic high state), the second logic signal SW2 is in the active state (e.g., logic high state). In an embodiment, the second logic circuit 52 may comprise two “AND” logic gates each of which may comprise two input terminals. In other embodiments, the second logic circuit 52 may comprise an “AND” logic gate having three input terminals.

The switch 53 may comprise a first terminal coupled to the first bootstrap node BST1, a second terminal coupled to the second bootstrap node BST2, and a control terminal configured to receive the second logic signal SW2. When the second logic signal SW2 is in the active state, the switch 53 is turned on so as to connect the first bootstrap node BST1 with the second bootstrap node BST2.

The diode 54 may be configured to prevent a current from flowing from the first bootstrap node BST1 to the second bootstrap node BST2. In an embodiment, an anode of the diode 54 is coupled to the second bootstrap node BST2, and a cathode of the diode 54 is coupled to the first bootstrap node BST1. In the exemplary embodiment of FIG. 5, the anode of the diode 54 is coupled to the first terminal of the switch 53, and the cathode of the diode 54 is coupled to the first bootstrap node BST1.

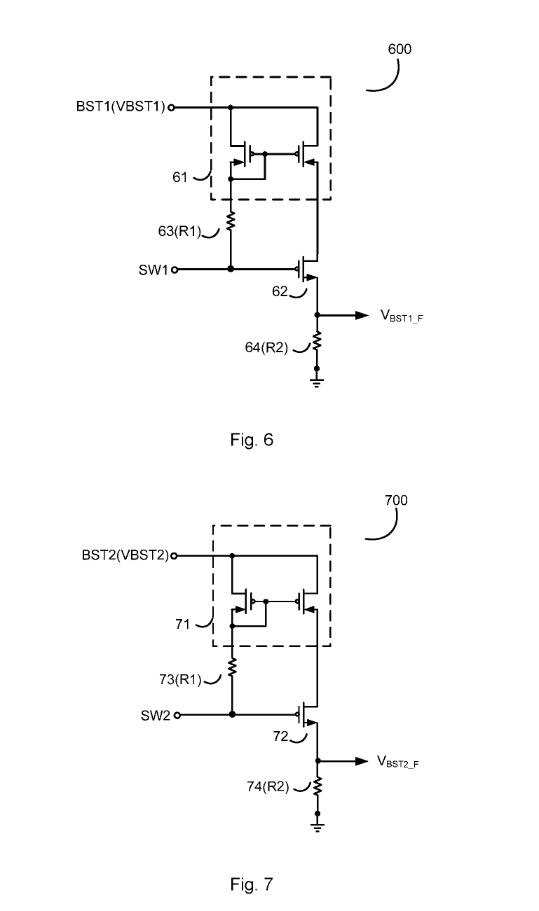

In an embodiment, the bootstrap circuit may further comprise a first feedback circuit configured to generate the first feedback signal VBST1_F based on the first bootstrap voltage VBST1, and a second feedback circuit configured to generate the second feedback signal VBST2_F based on the second bootstrap voltage VBST2. FIG. 6 illustrates a schematic diagram of a first feedback circuit 600 used for generating the first feedback signal VBST1_F in accordance with an exemplary embodiment of the present invention. As shown in FIG. 6, the first feedback circuit 600 may comprise a current mirror circuit 61, a transistor 62, a resistor 63 with a resistance R1 and a resistor 64 with a resistance R2. The current mirror circuit 61 may comprise a supply terminal coupled to the first bootstrap node BST1 to receive the first bootstrap voltage VBST1, a first current terminal coupled to the first switching node SW1 via the resistor 63, and a second current terminal. The transistor 62 may comprise a first terminal coupled to the second current terminal of the current mirror circuit 61, a control terminal coupled to the first switching node SW1, and a second terminal connected to the ground through the resistor 64. A common connection of the second terminal of the transistor 62 and the resistor 64 is regarded as an output terminal of the first feedback circuit 600 to provide the first feedback signal VBST1_F. In the exemplary embodiment of FIG. 6, the first feedback signal VBST1_F is equal to VBST1×R2/R1.

FIG. 7 illustrates a schematic diagram of a first feedback circuit 700 used for generating the second feedback signal VBST2_F in accordance with an exemplary embodiment of the present invention. As shown in FIG. 7, the second feedback circuit 700 may comprise a current mirror circuit 71, a transistor 72, a resistor 73 with a resistance R1 and a resistor 74 with a resistance R2. The current mirror circuit 71 may comprise a supply terminal coupled to the second bootstrap node BST2 to receive the second bootstrap voltage VBST2, a first current terminal coupled to the second switching node SW2 via the resistor 73, and a second current terminal. The transistor 72 may comprise a first terminal coupled to the second current terminal of the current mirror circuit 71, a control terminal coupled to the second switching node SW2, and a second terminal connected to the ground through the resistor 74. A common connection of the second terminal of the transistor 72 and the resistor 74 is regarded as an output terminal of the second feedback circuit 700 to provide the second feedback signal VBST2_F. In the exemplary embodiment of FIG. 7, the second feedback signal VBST2_F is equal to VBST2 ×R2/R1.

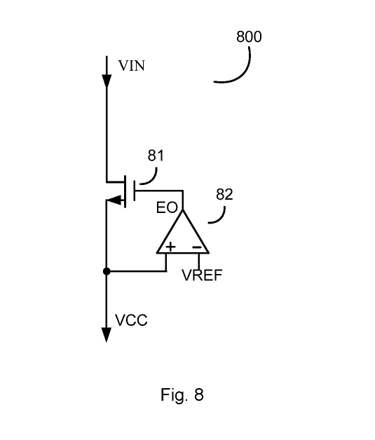

FIG. 8 illustrates a schematic diagram of a power supply generator 800 used to generate the power supply VCC in accordance with an exemplary embodiment of the present invention. In the exemplary embodiment of FIG. 8, the power supply generator 800 is illustrated as a low dropout linear regulator (LDO) comprising a transistor 81 and an error amplifier 82. The transistor 81 may have a first terminal configured to receive the input voltage signal VIN, a second terminal configured to provide the power supply VCC, and a control terminal. The error amplifier 82 may have a first input terminal configured to receive a reference voltage signal VREF, a second input terminal coupled to the second terminal of the transistor 81 to receive the power supply VCC, and an output terminal coupled to the control terminal of the transistor 81, wherein the error amplifier 82 is configured to amplify the difference of the reference voltage signal VREF and the power supply VCC to provide an error signal EO at the output terminal for controlling the transistor 81.

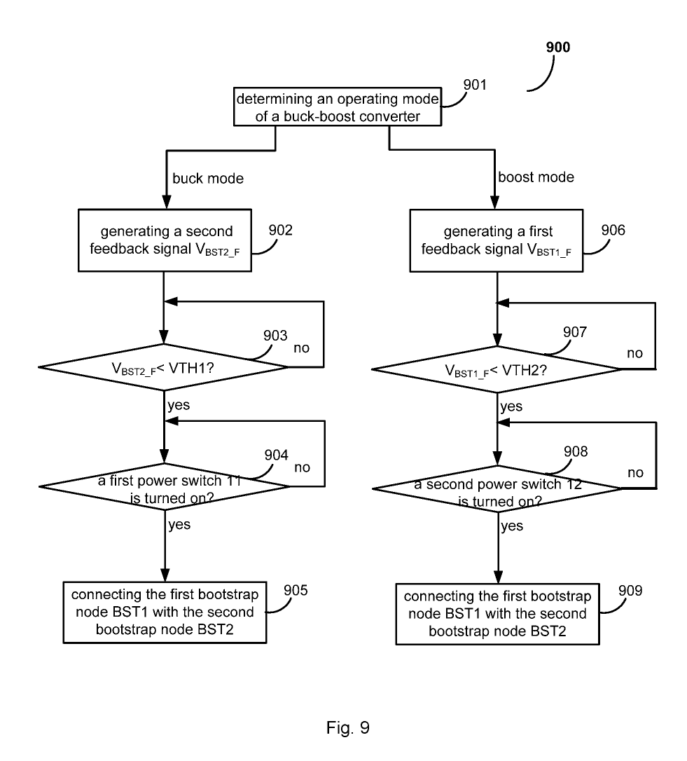

FIG. 9 illustrates a bootstrap voltage refresh method 900 for a buck-boost power converter (e.g., the buck-boost power converter 100 as shown in FIG. 2) in accordance with an exemplary embodiment of the present invention. The buck-boost power converter may comprise a first power switch (e.g., the first power switch 11 as shown in FIG. 2) and a third power switch (e.g., the third power switch 13 as shown in FIG. 2) coupled in series between an input port and a reference ground, a second power switch (e.g., the second power switch 12 as shown in FIG. 2) and a fourth power switch (e.g., the fourth power switch 14 as shown in FIG. 2) coupled in series between an output port and the reference ground, a first bootstrap capacitor (e.g., the first bootstrap capacitor 31 as shown in FIG. 2) configured to provide a first bootstrap voltage signal (e.g., the first bootstrap voltage signal VBST1 as shown in FIG. 2) used for driving of the first power switch, and a second bootstrap capacitor (e.g., the second bootstrap capacitor 33 as shown in FIG. 2) configured to provide a second bootstrap voltage signal (e.g., the second bootstrap voltage signal VBST2 as shown in FIG. 2) used for driving of the second power switch, wherein the first power switch and the third power switch have a common connection referred to as a first switching node (e.g., the first switching node SW1 as shown in FIG. 2), and the second power switch and the fourth power switch have a common connection referred to as a second switching node (e.g., the second switching node SW2 as shown in FIG. 2), and wherein an inductor (e.g., the inductor 15 as shown in FIG. 2) is coupled between the first switching node and the second switching node. The method 900 may comprise steps 901-909.

In step 901, determining an operating mode of the buck-boost power converter.

When the buck-boost power converter operates in the buck mode, the bootstrap voltage refresh method 900 may go through steps 902-905. When the buck-boost power converter operates in the boost mode, the bootstrap voltage refresh method 900 may go through steps 906-909.

In step 902, generating a second feedback signal VBST2_F indicative of the second bootstrap voltage signal VBST2.

In step 903, comparing the second feedback signal VBST2_F with a first predetermined threshold VTH1 to determine whether the second feedback signal VBST2_F is smaller than the first predetermined threshold VTH1. If the second feedback signal VBST2_F is smaller than the first predetermined threshold VTH1, turns to step 904, otherwise, continues to step 903.

In step 904, determining whether the first power switch 11 is turned on. If the first power switch 11 is turned on, turns to step 905, otherwise, continues to step 904.

In step 905, connecting the first bootstrap node BST1 with the second bootstrap node BST2. Thus, the first bootstrap voltage signal VBST1 is able to charge the second bootstrap capacitor 33 to refresh the second bootstrap voltage signal VBST2.

In step 906, generating a first feedback signal VBST1_F indicative of the first bootstrap voltage signal VBST1.

In step 907, comparing the first feedback signal VBST1_F with a second predetermined threshold VTH2 to determine whether the first feedback signal VBST1_F is smaller than the second predetermined threshold VTH2. If the first feedback signal VBST1_F is smaller than the second predetermined threshold VTH2, turns to step 908, otherwise, continues to step 907. In an embodiment, the first predetermined threshold VTH1 is equal to the second predetermined threshold VTH2.

In step 908, determining whether the second power switch 12 is turned on. If the second power switch 12 is turned on, turns to step 909, otherwise, continues to step 908.

In step 909, connecting the first bootstrap node BST1 with the second bootstrap node BST2. Thus, the second bootstrap voltage signal VBST2 is able to charge the first bootstrap capacitor 31 to refresh the first bootstrap voltage signal VBST1.

It should be understood, in the exemplary embodiment of FIG. 9, step 904 is illustrated behind of step 903, and step 908 is illustrated behind of step 907. But in actual operation applications, step 903 and step 904 may be happened simultaneously, and step 907 and step 908 may be happened simultaneously.

Obviously many modifications and variations of the present invention are possible in light of the above teachings. It is therefore to be understood that within the scope of the appended claims the invention may be practiced otherwise than as specifically described. It should be understood, of course, the foregoing invention relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A driving circuit for a buck-boost power converter having a first power switch and a third power switch coupled in series between an input port and a reference ground, and a second power switch and a fourth power switch coupled in series between an output port and the reference ground, comprising:
a first bootstrap capacitor, coupled between a first bootstrap node and a common connection of the first power switch and the third power switch, and configured to provide a first bootstrap voltage signal to drive the first power switch;
a second bootstrap capacitor, coupled between a second bootstrap node and a common connection of the second power switch and the fourth power switch, and configured to provide a second bootstrap voltage signal to drive the second power switch;
a power supply, wherein the first bootstrap node and the second bootstrap node are respectively coupled to the power supply; and
a bootstrap refresh circuit; wherein
when the buck-boost power converter operates in a buck mode and the second bootstrap voltage signal is smaller than a first refresh threshold, the bootstrap refresh circuit is configured to connect the first bootstrap node with the second bootstrap node when the first power switch is turned on; and wherein
when the buck-boost power converter operates in a boost mode and the first bootstrap voltage signal is smaller than a second refresh threshold, the bootstrap refresh circuit is configured to connect the first bootstrap node with the second bootstrap node when the second power switch is turned on.

2. The driving circuit of claim 1, wherein the bootstrap refresh circuit comprises:
a first bootstrap refresh circuit; and
a second bootstrap refresh circuit; wherein
when the buck-boost power converter operates in the buck mode, the second bootstrap refresh circuit is disabled, and the first bootstrap refresh circuit is enabled, wherein once the second bootstrap voltage signal is smaller than the first refresh threshold, the first bootstrap refresh circuit is configured to connect the first bootstrap node with the second bootstrap node when the first power switch is turned on; and wherein
when the buck-boost power converter operates in the boost mode, the first bootstrap refresh circuit is disabled, and the second bootstrap refresh circuit is enabled, wherein once the first bootstrap voltage signal is smaller than the second refresh threshold, the second bootstrap refresh circuit is configured to connect the first bootstrap node with the second bootstrap node when the second power switch is turned on; and wherein
when the buck-boost power converter operates in a buck-boost mode, both the first bootstrap refresh circuit and the second bootstrap refresh circuit are disabled.

3. The driving circuit of claim 2, further comprising:
a first feedback circuit, configured to generate a first feedback signal indicative of the first bootstrap voltage signal; and
a second feedback circuit, configured to generate a second feedback signal indicative of the second bootstrap voltage.

4. The driving circuit of claim 3, wherein the first feedback circuit comprises:
a current mirror circuit, comprising a supply terminal coupled to the first bootstrap node to receive the first bootstrap voltage, a first current terminal coupled to the first switching node via a first resistor, and a second current terminal; and
a transistor, comprising a first terminal coupled to the second current terminal of the current mirror circuit, a control terminal coupled to the common connection of the first power switch and the third power switch, and a second terminal connected to the ground through a second resistor, wherein the voltage on a common connection of the second terminal of the transistor and the second resistor is regarded as the first feedback signal.

5. The driving circuit of claim 3, wherein the second feedback circuit comprises:
a current mirror circuit, comprising a supply terminal coupled to the second bootstrap node to receive the second bootstrap voltage, a first current terminal coupled to the second switching node via a first resistor, and a second current terminal; and
a transistor, comprising a first terminal coupled to the second current terminal of the current mirror circuit, a control terminal coupled to the common connection of the second power switch and the fourth power switch, and a second terminal connected to the ground through a second resistor, wherein the voltage on a common connection of the second terminal of the transistor and the second resistor is regarded as the second feedback signal.

6. The driving circuit of claim 3, wherein the first bootstrap refresh circuit comprises:
a first comparator, configured to receive the second feedback signal and a first predetermined threshold, and further configured to compare the second feedback signal with the first predetermined threshold to generate a first refresh signal, wherein the first predetermined threshold is proportional to the first refresh threshold, and wherein when the second feedback signal is smaller than the first predetermined threshold, the first refresh signal is in the active state;
a first logic circuit, configured to receive the first refresh signal, a first enable signal, and a first control signal, and further configured to conduct a logic operation to the first refresh signal, the first enable signal and the first control signal to generate a first logic signal, wherein the first control signal is configured to control the first power switch on and off, when the first control signal is active, the first power switch is turned on, and wherein the first enable signal is configured to enable the first bootstrap refresh circuit, when the first enable signal is active, the first bootstrap refresh circuit is enabled, and wherein when all of the first refresh signal, the first enable signal and the first control signal are active, the first logic signal is active; and
a switch, comprising a first terminal coupled to the first bootstrap node, a second terminal coupled to the second bootstrap node, and a control terminal configured to receive the first logic signal, wherein when the first logic signal is in the active state, the switch is turned on.

7. The driving circuit of claim 6, wherein the first bootstrap refresh circuit further comprises a diode having an anode coupled to the first second bootstrap node, and a cathode coupled to the second bootstrap node.

8. The driving circuit of claim 3, wherein the second bootstrap refresh circuit comprises:
a second comparator, configured to receive the first feedback signal, a second predetermined threshold, and further configured to compare the first feedback signal with the second predetermined threshold to generate a second refresh signal, wherein the second predetermined threshold is proportional to the second refresh threshold, and wherein when the first feedback signal is smaller than the second predetermined threshold, the second refresh signal is in the active state;
a second logic circuit, configured to receive the second refresh signal, a second enable signal and a second control signal, and further configured to conduct a logic operation to the second refresh signal, the second enable signal and the second control signal to provide a second logic signal, wherein the second control signal is configured to control the second power switch on and off, when the second control signal is active, the second power switch is turned on, and wherein the second enable signal is configured to enable the second bootstrap refresh circuit, when the second enable signal is active, the second bootstrap refresh circuit is enabled, and wherein when all of the second refresh signal, the second enable signal and the second control signal are active, the second logic signal is active; and
a switch, comprising a first terminal coupled to the first bootstrap node, a second terminal coupled to the second bootstrap node, and a control terminal configured to receive the first logic signal, wherein when the second logic signal is in the active state, the switch is turned on.

9. The driving circuit of claim 8, wherein the first bootstrap refresh circuit further comprises a diode having an anode coupled to the second bootstrap node, and a cathode coupled to the first bootstrap node.

10. The driving circuit of claim 1, wherein the first refresh threshold is equal to the second refresh threshold.

11. The driving circuit of claim 1, further comprising:
a first driver, having an input terminal configured to receive a first control signal, a first supply terminal coupled to the first bootstrap node to receive the first bootstrap voltage signal, a second supply terminal coupled to the common connection of the first power switch and the third power switch, and an output terminal configured to provide a first driving signal to drive the first power switch on and off;
a second driver, comprising an input terminal configured to receive a second control signal, a first supply terminal coupled to the second bootstrap node to receive the second bootstrap voltage signal, a second supply terminal coupled to the common connection of the second power switch and the fourth power switch, and an output terminal configured to provide a second driving signal to drive the second power switch on and off;
a third driver, configured to receive a third control signal to generate a third driving signal to drive the third power switch on and off; and
a fourth driver, configured to receive a fourth control signal to generate a fourth driving signal to drive the fourth power switch on and off.

12. A control circuit for a buck-boost power converter having a first power switch and a third power switch coupled in series between an input port and a reference ground, a second power switch and a fourth power switch coupled in series between an output port and the reference ground, comprising:
a driving circuit, comprising:
a first bootstrap capacitor, coupled between a first bootstrap node and a common connection of the first power switch and the third power switch and configured to provide a first bootstrap voltage signal to drive the first power switch;
a second bootstrap capacitor, coupled between a second bootstrap node and a common connection of the second power switch and the fourth power switch, and configured to provide a second bootstrap voltage signal to drive the second power switch; and
a bootstrap refresh circuit; and
a power supply, wherein the first bootstrap node and the second bootstrap node are respectively coupled to the power supply; and
a controller, configured to receive a feedback signal indicative of an output voltage signal, and further configured to generate a first control signal, a second control signal, a third control signal, a fourth control signal, a first enable signal and a second enable signal based on the feedback signal, wherein the first control signal, the second control signal, the third control signal and the fourth control signal are respectively configured to control the first power switch, the second power switch, the third power switch and the fourth power switch; and wherein
when the buck-boost power converter operates in a buck mode and the second bootstrap voltage signal is smaller than a first refresh threshold, the first enable signal is configured to enable the bootstrap refresh circuit to connect the first bootstrap node with the second bootstrap node when the first power switch is turned on; and wherein
when the buck-boost power converter operates in a boost mode and the first bootstrap voltage signal is smaller than a second refresh threshold, the second enable signal is configured to enable the bootstrap refresh circuit to connect the first bootstrap node with the second bootstrap node when the second power switch is turned on.

13. The control circuit of claim 12, wherein the bootstrap refresh circuit comprises:
a first bootstrap refresh circuit; and
a second bootstrap refresh circuit; wherein
when the buck-boost power converter operates in the buck mode, the second bootstrap refresh circuit is disabled by the second enable signal, and the first bootstrap refresh circuit is enabled by the first enable signal, wherein once the second bootstrap voltage signal is smaller than the first refresh threshold, the first bootstrap refresh circuit is configured to connect the first bootstrap node with the second bootstrap node when the first power switch is turned on; and wherein
when the buck-boost power converter operates in the boost mode, the first bootstrap refresh circuit is disabled by the first enable signal, and the second bootstrap refresh circuit is enabled by the second enable signal, wherein once the first bootstrap voltage signal is smaller than the second refresh threshold, the second bootstrap refresh circuit is configured to connect the first bootstrap node with the second bootstrap node when the second power switch is turned on; and wherein
when the buck-boost power converter operates in a buck-boost mode, both the first bootstrap refresh circuit and the second bootstrap refresh circuit are respectively disabled by the first enable signal and the second enable signal.

14. The control circuit of claim 12, further comprising:
a first driver, having an input terminal configured to receive the first control signal, a first supply terminal coupled to the first bootstrap node to receive the first bootstrap voltage signal, a second supply terminal coupled to the common connection of the first power switch and the third power switch, and an output terminal configured to provide a first driving signal to drive the first power switch on and off;
a second driver, comprising an input terminal configured to receive the second control signal, a first supply terminal coupled to the second bootstrap node to receive the second bootstrap voltage signal, a second supply terminal coupled to the common connection of the second power switch and the fourth power switch, and an output terminal configured to provide a second driving signal to drive the second power switch on and off;
a third driver, configured to receive a third control signal to generate the third driving signal to drive the third power switch on and off; and
a fourth driver, configured to receive the fourth control signal to generate a fourth driving signal to drive the fourth power switch on and off.

15. A bootstrap voltage refresh method for a buck-boost power converter having a first power switch and a third power switch coupled in series between an input port and a reference ground, a second power switch and a fourth power switch coupled in series between an output port and the reference ground, a first bootstrap capacitor coupled between a first bootstrap node and a common connection of the first power switch and the third power switch and configured to provide a first bootstrap voltage signal to drive the first power switch, and a second bootstrap capacitor coupled between a second bootstrap node and a common connection of the second power switch and the fourth power switch and configured to provide a second bootstrap voltage signal to drive the second power switch, and the bootstrap voltage refresh method comprising:
determining an operating mode of the buck-boost power converter;
when the operating mode is a buck mode:
determining whether the second bootstrap voltage signal is smaller than a first refresh threshold;
determining whether the first power switch is turned on; and
connecting the first bootstrap node with the second bootstrap node when the second bootstrap voltage is smaller than the first refresh threshold and the first power switch is turned on;
when the operating mode is a boost mode:
determining whether the first bootstrap voltage signal is smaller than a second refresh threshold;
determining whether the second power switch is turned on; and
connecting the first bootstrap node with the second bootstrap node when the first bootstrap voltage is smaller than the second refresh threshold and the second power switch is turned on.

16. The bootstrap voltage refresh method of claim 15, wherein the step of determining whether the second bootstrap voltage signal is smaller than a first refresh threshold comprises:
generating a second feedback signal indicative of the second bootstrap voltage signal; and
comparing the second feedback signal with a first predetermined threshold, wherein the first predetermined threshold is proportional to the first refresh threshold.

17. The bootstrap voltage refresh method of claim 15, wherein the step of determining whether the first bootstrap voltage signal is smaller than a second refresh threshold comprises:
generating a first feedback signal indicative of the first bootstrap voltage signal; and
comparing the first feedback signal with a second predetermined threshold, wherein the second predetermined threshold is proportional to the second refresh threshold.

18. The bootstrap voltage refresh method of claim 15, wherein the first refresh threshold is equal to the second refresh threshold.
